(19) United States
(12) Patent Application Publication
(10) Pub. No.: US 2010/0287010 A1
(43) Pub. Date: Nov. 11, 2010

(54) System, method and program for managing disaster recovery

(75) Inventors: Fronz F. Batot, Austin, TX (US); Randy S. Johnson, Ofallon, MO (US); Tedrick N. Northway, Wood River, IL (US); Paul D. Peterson, Round Rock, TX (US); Howard N. Smallowitz, Austin, TX (US)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 11/523,200

(22) Filed: Sep. 19, 2006

(51) Int. Cl. G06Q 10/00; G06Q 90/00

(52) U.S. Cl. 705/7; 705/500

(57) ABSTRACT

System, method and program product for prioritizing a multiplicity of management services which support physical disaster recovery operations. Criticality of each of the management services is determined. An urgency of recovery of each of the management services is determined. Respective numbers of services which support or depend on each of the management services is determined. A priority to perform each of the management services based on (a) the criticality of each management service, urgency of each management service and number of services which support or depend on each management service is determined. In one example, the priority to perform each management service is based on the criticality multiplied times the urgency multiplied times the number of services which support or depend on each management service.

### FIELD OF THE INVENTION

The present invention relates generally to disaster recovery management, and more specifically to management services that support physical disaster recovery operations.

### BACKGROUND OF THE INVENTION

Disasters can be caused by hurricane, tornado, flood, terrorist attack, war, etc., and may impact many different types of physical services or resources. For example, a severe hurricane can impact housing, food supply, water supply, roads, public transportation, electric power lines, gas supply, sanitation, hospitals, schools, telecommunications, etc. A recovery operation typically follows each disaster, and may be managed by a local, state or federal agency such as FEMA. The recovery operation attempts to restore all physical services and resources that existed prior to the disaster and also provide physical services and resources for emergency and interim relief.

Known types of recovery operations prioritize the restoration of services and resources based on the criticality and urgency of each service and resource. A document entitled “Disaster Recovery Planning” by Peter Fallara discloses that recovery of resources and business processes should be prioritized based on time sensitivity and criticality, beginning the recovery with the most critical/low tolerance process. The process may begin before the disaster strikes with a risk assessment. Risk management identifies the business processes, threats and vulnerabilities, and classifies them by how critical they are to the overall business. With this information, the next step is to determine the impact a particular process has if it is unavailable for a period of time. A determination is also made as to the effect the failed process has on other business resources and processes.

Most recovery efforts require information processing, information analysis and other management services for physical recovery operations. The physical recovery operations include (a) search and rescue operations, (b) restoration of transportation infrastructure and services, (c) remote evacuation services, (d) command operations, (e) restoration of power supply infrastructure and services, (f) restoration of telecommunications infrastructure, (g) restoration of sanitation services, (h) restoration of food and water sources, (i) damage, (j) morgues, (k) safety infrastructure, (l) security services, (m) media services, (n) local, state and federal coordination, (o) military support, (p) procurement operations, (q) construction, (r) funding, and (s) notification processes. In the past, there have been difficulties in prioritizing the information processing, information analysis and other management services that support the physical recovery operations.

An object of the present invention is to better prioritize services or resources associated with a disaster recovery.

Another object of the present invention is to better prioritize information processing, information analysis and other management services in support of physical disaster recovery operations.

### SUMMARY OF THE INVENTION

The present invention resides in a system, method and program product for prioritizing a multiplicity of management services which support physical disaster recovery operations. Criticality of each of the management services is determined. An urgency of recovery of each of the management services is determined. Respective numbers of services which support or depend on each of the management services is determined. A priority to perform each of the management services based on (a) the criticality of each management service, urgency of each management service and number of services which support or depend on each management service is determined.

In accordance with a feature of the present invention, in one example, the priority to perform each management service is based on the criticality multiplied times the urgency multiplied times the number of services which support or depend on each management service.

### BRIEF DESCRIPTION OF THE FIGURES

FIG. 1 is a block diagram of a disaster recovery management system, according to the present invention.

FIG. 2 is a flow chart of a disaster recovery management program within the disaster recovery management system of FIG. 1.

### DETAILED DESCRIPTION OF THE PREFERRED EMBODIMENTS

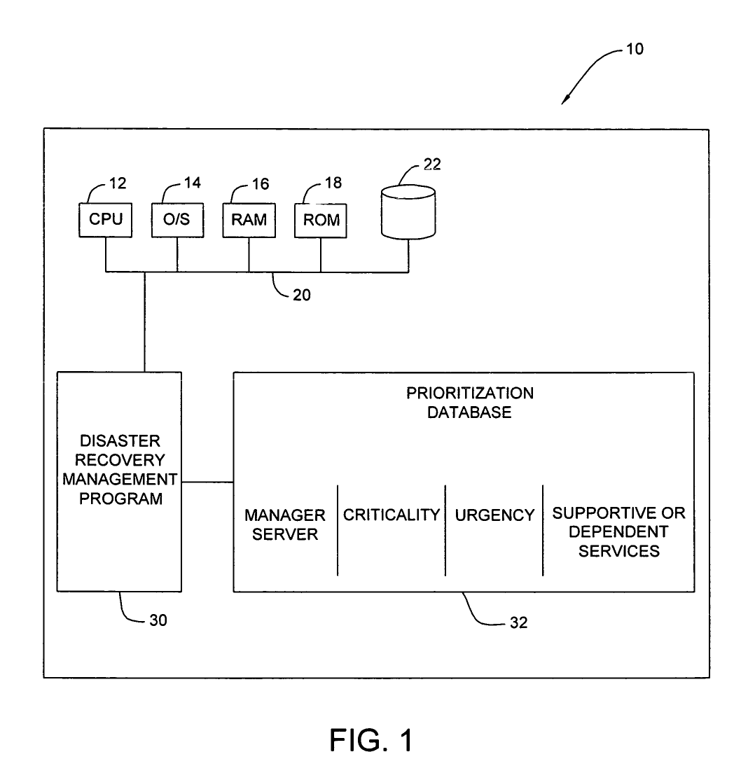

The present invention will now be described in detail with reference to the figures. FIG. 1 illustrates a computer 10 comprising a known CPU 12, operating system 14, RAM 16 and ROM 18 all connected on a common bus 20, and storage 22. A disaster recovery management program 30 is installed and executing in computer 10 and utilizes a prioritization database 32, according to the present invention.

Disaster recovery management program 30 manages physical disaster recovery operations by providing information processing, information analysis and other management of physical recovery operations. Program 30 can manage physical disaster recovery operations such as (a) search and rescue, (b) transportation restoration, (c) remote evacuation, (d) command operations, (e) power restoration, (f) telecommunications restoration, (g) sanitation restoration, (h) food and water restoration, (i) damage assessment, (j) morgue services, (k) safety facilities restoration, (l) security facilities restoration, (m) media restoration, (n) local, state and federal personnel management, (o) military protection, (p) procurement operations, (q) construction, (r) procurement of funding and (s) notification operations.

Database 32 is defined before a disaster occurs, and lists in a first column each management service that may be needed to support a disaster recovery. For each such management service, database 32 lists the criticality of the management service, the urgency of the management service, and which other management service(s) or other service(s) support or depend on the management service listed in the first column. The “criticality” of the management service is the importance of the management service and the corresponding physical service or resource being managed to human safety, well being, number of people affected, public health, financial cost and economic impact. Based on experience, research and logic, a person specifies the “criticality” of each management service and enters the specification into database 32. The “urgency” of the management service is the importance of prompt performance of the management service and prompt recovery of the corresponding physical service or resource being managed. For example, evacuation of stranded people and restoration of safety facilities (such as hospitals) are more urgent than reconstruction of housing so management of the evacuation of stranded people and management of safety facilities are more urgent than management of reconstruction of housing. Based on experience, research and logic, a person specifies the “urgency” of each management service and enters the specification into database 32. A person also determines from experience, research and logic which other services support or depend on recovery of the management service listed in the first column. For example, management of morgues is supported by both management of search and rescue efforts and management of medical support. As another example, management of medical support operations is supported by management of search and rescue operations. As another example, management of restoration of electric power is dependent on management of pumping out flood water because electric power cannot be restored until the flood water is removed. As another example, management of public transportation is dependent on management of cleanup and management of road reconstruction because public transportation cannot be restored until debris is removed from roads and the roads are reconstructed. The following Prioritization Table lists an example of the foregoing data in database 32:

Prioritization Table

| | Criticality of | Urgency of | Services which Support or |
|---|---|---|---|
| Management Service | Management | Management | Depend on Management |
| to be Prioritized | Service | Service | Service to be Prioritized |
| Search and Rescue Analysis | 1 | 1 | Transportation Analysis |
| and Management | | | and Management |
| Transportation Analysis | 1 | 5 | Search and Rescue Analysis |
| and Management | | | and Management |
| Remote Evacuation Analysis | 1 | 5 | Transportation Analysis |
| and Management | | | and Management |
| Medical Support Analysis | 2 | 3 | Search and Rescue Analysis |
| and Management | | | and Management |
| Command Operations | 2 | 4 | Local, State and Federal |
| Management | | | Coordination |
| Power Analysis and | 2 | 5 | Local, State and Federal |
| Management | | | Coordination |
| | | | Construction Analysis and |
| | | | Coordination |
| Telecommunications Analysis | 2 | 7 | Local, State and Federal |
| and Management | | | Coordination |
| | | | Construction Analysis and |
| | | | Coordination |
| Sanitation Analysis and | 2 | 8 | Local, State and Federal |
| Management | | | Coordination |
| | | | Construction Analysis and |
| | | | Coordination |
| Food and Water Analysis | 3 | 2 | Transportation Analysis and |
| and Management | | | |
| Damage Analysis | 3 | 2 | Local, State and Federal |
| and Management | | | Coordination |
| Morgue Analysis | 3 | 4 | Search and Rescue Analysis |
| and Management | | | and Management |
| | | | Medical Support Analysis |
| | | | and Management |
| Safety Analysis and | 3 | 6 | Local, State and Federal |
| Management | | | Coordination |
| Security Analysis | 4 | 2 | Local, State and Federal |
| and Management | | | Coordination |
| | | | Military Support Analysis |
| | | | and Coordination |
| Media Coordination | 4 | 3 | Notification Management |
| Local, State and | 4 | 5 | Command Operations |
| Federal Construction | | | Management |
| Military Support Analysis | 4 | 9 | Command Operations |
| and Management | | | Management |
| Procurement Analysis | 5 | 1 | Local, State and Federal |
| and Management | | | Coordination |
| Construction Analysis | 5 | 4 | Funding Management |
| and Coordination | | | |
| Funding Management | 5 | 5 | No dependencies |
| Notification Management | 5 | 8 | Media Coordination |

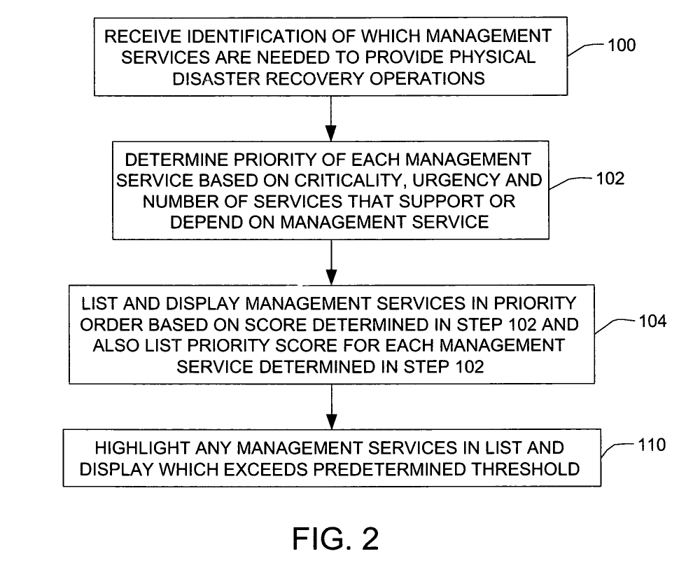

FIG. 2 is a flow chart illustrating operation and function of disaster recovery management program 30. When a disaster strikes, an administrator identifies to disaster recovery management program 30 (via a GUI) which management services are needed based on which physical disaster recovery operations are needed, and program 30 records this information in database 32 (step 100). Next, program 30 determines the priority of each management service based on its criticality, urgency and number of services that support or are dependent on the listed management service, as specified in database 32 (step 102). By way of example, program 30 executes the following algorithm in step 102 to determine the priority of each management service, based on the data in database 32:

Priority=(Criticality×Urgency×(#Support or Dependent))/Sum(Criticality+Urgency)

where “#Support or Dependent” is the number of services that support or depend on the listed management service.
In the illustrated embodiment, the services that support or depend on the management service listed in the first column of the Prioritization Table are listed in the last column of the Prioritization Table. In this example, there is a single service which supports each of the Management Services except as follows. There are two services which support each of the “Power Analysis and Management”, “Telecommunications Analysis and Management”, “Sanitation Analysis and Management”, “Morgue Analysis and Management”, and “Security Analysis and Management” management services. There is no service which supports the “Funding Management” management service. Although not listed in example of the Prioritization Table specified above, there can be dependent management services in the last column instead of or in addition to the supportive management services in the last column.

Next, disaster recovery management program 30 lists and displays the management services in their priority order, and also lists and displays the priority score of each management service, based on the results of the calculations performed in step 102 (step 104). In the illustrated example, the following is the priority order and score for each of the management services:

| Management Service | Priority |
|---|---|
| Funding Management | (5 * 5 * 0)/Sum(5 + 5) = 0.0 |
| Transportation Analysis and Management | (1 * 5 * 1)/Sum(1 + 5) = 0.8 |
| Remote Evacuation Analysis and | (1 * 5 * 1)/Sum(1 + 5) = 0.8 |
| Management | |
| Procurement Analysis and Management | (5 * 1 * 1)/Sum(5 + 1) = 0.8 |
| Search and Rescue Analysis and | (1 * 1 * 1)/Sum(1 + 1) = 1.0 |
| Management | |
| Medical Support Analysis and | (2 * 3 * 1)/Sum(2 + 3) = 1.2 |
| Management | |
| Food and Water Analysis and | (3 * 2 * 1)/Sum(3 + 2) = 1.2 |
| Management | |
| Damage Analysis and Management | (3 * 2 * 1)/Sum(3 + 2) = 1.2 |
| Command Operations Management | (2 * 4 * 1)/Sum(2 + 4) = 1.3 |
| Media Coordination | (4 * 3 * 1)/Sum(4 + 3) = 1.7 |
| Safety Analysis and Management | (3 * 6 * 1)/Sum(3 + 6) = 2.0 |
| Local, State and Federal Construction | (4 * 5 * 1)/Sum(4 + 5) = 2.2 |
| Construction Analysis and Coordination | (5 * 4 * 1)/Sum(5 + 4) = 2.2 |
| Security Analysis and Management | (4 * 2 * 2)/Sum(4 + 2) = 2.6 |
| Military Support Analysis and | (4 * 9 * 1)/Sum(4 + 9) = 2.8 |
| Management | |
| Power Analysis and Management | (2 * 5 * 2)/Sum(2 + 5) = 2.9 |
| Telecommunications Analysis and | (2 * 7 * 2)/Sum(2 + 7) = 3.1 |
| Management | |
| Notification Management | (5 * 8 * 1)/Sum(5 + 8) = 3.1 |
| Sanitation Analysis and Management | (2 * 8 * 2)/Sum(2 + 8) = 3.2 |
| Morgue Analysis and Management | (3 * 4 * 2)/Sum(3 + 4) = 3.4 |

Next, disaster recovery management program 30 highlights any of the management services whose priority score calculated in step 102 exceeds a predetermined threshold (step 110).

Disaster recovery management program 30 can be loaded into computer 10 from a computer readable media such as magnetic tape or disk, optical media, DVD, memory stick, semiconductor memory, etc. or downloaded from Internet 40 via a TCP/IP adapter card 42.

Based on the foregoing, a system, method and program product for managing disaster recovery have been disclosed. However, numerous modifications and substitutions can be made without deviating from the scope of the present invention. For example, deployment of emergency generators could be substituted for restoring electrical services. Therefore, the present invention has been disclosed by way of illustration and not limitation, and reference should be made to the following claims to determine the scope of the present invention.

1. A method for prioritizing a multiplicity of management services which manage physical disaster recovery operations, the method comprising the steps of:
a computer determining from a database a criticality of each of the management services;
the computer determining from a database an urgency of recovery of each of the management services;
the computer determining from a database respective numbers of the management services which support each of the management services; and
the computer determining and electronically reporting a priority to perform each of the management services based on (a) the criticality of said each management service, (b) the urgency of said each management service and (c) the number of the management services which support said each management service.

2. A method as set forth in claim 1 wherein the step of the computer determining the priority to perform said each management service is based on an equation in which the higher the criticality the higher the priority to perform said each management service, the higher the urgency the higher the priority to perform said each management service and the higher the number of the management services which support said each management service the hither the priority to perform said each management service.

3. A method as set forth in claim 1 wherein the management services comprise information processing and analysis of physical disaster recovery operations.

4. A computer program product comprising a computer-readable tangible storage device(s) and computer-readable program instructions stored on the computer-readable tangible storage device(s) to prioritize a multiplicity of management services which manage physical disaster recovery operations, the computer-readable program instructions, when executed by a CPU:
determine from a database a criticality of each of the management services;
determine from a database an urgency of recovery of each of the management services;
determine from a database respective numbers of the management services which support each of the management services; and
determine a priority to perform each of the management services based on (a) the criticality of said each management service, (b) the urgency of said each management service and (c) the number of the management services which support said each management service.

5. A computer program product as set forth in claim 4 wherein the computer-readable program instructions, when executed by the CPU, determine the priority to perform said each management service based on an equation in which the higher the criticality the higher the priority to perform said each management service, the higher the urgency the higher the priority to perform said each management service, and the higher the number of services which support said each management service the higher the priority to perform said each management service.

6. A computer program product as set forth in claim 4 wherein the management services comprise information processing and analysis of physical disaster recovery operations.

7. A method for prioritizing a multiplicity of management services which manages physical disaster recovery operations, the method comprising the steps of:
a computer determining from a database a criticality of each of the management services;
the computer determining from a database an urgency of recovery of each of the management services;
the computer determining from a database respective numbers of the management services which depend on each of the management services; and
the computer determining and electronically reporting a priority to perform each of the management services based on (a) the criticality of said each management service, (b) the urgency of said each management service and (c) the number of management services which depend on said each management service.

8. A method as set forth in claim 7 wherein the step of the computer determining the priority to perform said each management service is based on an equation in which the higher the criticality the higher the priority to perform said each management service, the higher the urgency the higher the priority to perform said each management service, and the higher the number of management services which depend on said each management service the higher the priority to perform said each management service.

9. A method as set forth in claim 7 wherein the management services comprise information processing and analysis of physical disaster recovery operations.

10. A computer program product comprising a computer-readable tangible storage device(s) and computer-readable program instructions stored on the computer-readable tangible storage device(s) to prioritize a multiplicity of management services which manage physical disaster recovery operations, the computer-readable program instructions, when executed by a CPU:
determine from a database a criticality of each of the management services;
determine from a database an urgency of recovery of each of the management services;
determine from a database respective numbers of the management services which depend on each of the management services; and
determine and electronically report a priority to perform each of the management services based on (a) the criticality of said each management service, (b) the urgency of said each management service and (c) the number of management services which depend on said each management service.

11. The computer program product as set forth in claim 10 wherein the computer-readable program instructions, when executed by the CPU, determine the priority to perform said each management service based on an equation in which the higher the criticality the higher the priority to perform said each management service, the higher the urgency the higher the priority to perform said each management service, and the higher the number of management services which depend on said each management service the higher the priority to perform said each management service.

12. The computer program product as set forth in claim 10 wherein the management services comprise information processing and analysis of physical disaster recovery operations.
